(19) United States
(12) Patent Application Publication
(10) Pub. No.: US 2022/0190781 A1
(43) Pub. Date: Jun. 16, 2022

(54) ROW-TO-ROW BONDING JUMPER

(71) Applicant: PEGASUS SOLAR, INC., Richmond, CA (US)

(72) Inventors: Erich Kai Stephan, Richmond, CA (US); Glenn Harris, Richmond, CA (US); Peter Wilke, Richmond, CA (US); Nicholas Wenzel, Richmond, CA (US); James Hsieh, Richmond, CA (US)

(21) Appl. No.: 17/118,771

(22) Filed: Dec. 11, 2020

(51) Int. Cl. H02S 40/36; H02S 30/10; H01R 4/26; H01R 4/48

(52) U.S. Cl. CPC H02S 40/36; H01R 4/48; H01R 4/26; H02S 30/10

(57) ABSTRACT

An electrically conductive bond jumper connects two solar modules, and is affixed to the solar modules with u-shaped spring grips on each end. The spring grips have sharp pointed teeth to penetrate coatings on the solar modules and enhance the electrical connection between the solar modules.

### BACKGROUND

Current rooftop solar arrays often consist of more than one row of solar modules. These rows of solar modules typically are electrically bonded with a copper wire connected using a fastening mechanism to each row of solar modules. This causes an excessive amount of wire to be used to electrically bond adjacent rows of solar modules.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be limiting of its scope, the principles herein are described and explained with additional specificity and detail through the use of the accompanying drawings in which:

FIG. 1 illustrates an isometric view of a Bond Jumper 100;

FIG. 2 illustrates a close-up isometric view of the Spring Grip 102;

FIG. 3 illustrates the Bond Jumper 100 installed on a First Solar Module 301;

FIG. 4 illustrates a Second Solar Module 303 adjacent to a First Solar Module 301;

FIG. 5 illustrates an underside angle view of the two solar modules with a Bond Jumper 100 installed;

FIG. 6 illustrates an underside view of the two solar modules with a Bond Jumper 100 installed;

FIG. 7 illustrates a cut-away side view of a Bond Jumper 100 installed on a First Solar Module 301; and

FIG. 8 illustrates an alternative example of the present invention wherein the Body 101 is straight.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

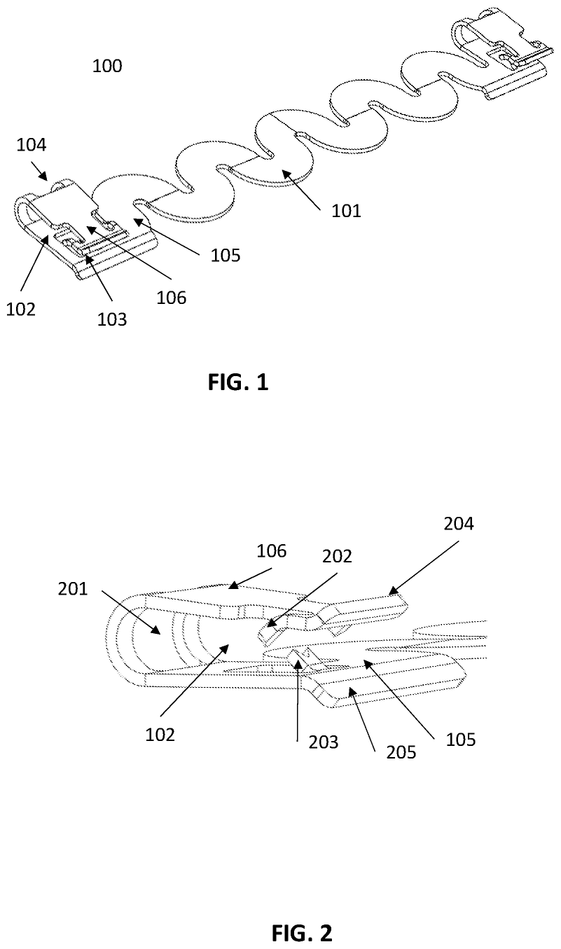

FIG. 1 illustrates an isometric view of a Bond Jumper 100. The Bond Jumper 100 may have a central s-shaped Body 101 with two ends that may have symmetric features. On the end of Body 101 may be a u-shaped Spring Grip 102 formed out of the Body 101. Spring Grip 102 has a curved Bend 104 on one side that forms the back side of the Spring Grip 102. Spring Grip 102 may have a Mouth 103 opposite of the Bend 104. The Bend 104 may have its bend axis substantially parallel with the length of the Body 101. Spring Grip 102 has a Lower Surface 105 that may be a continuation and thus planar with the Body 101, and an Upper Surface 106 opposite the Lower Surface 105. The Lower Surface 105 and Upper Surface 106 are generally planar. The Upper Surface 106 angles down towards the Lower Surface 105 away from the Bend 104. Bond Jumper 100 may be made from a substantially uniformly thick piece of conductive sheet metal, such as aluminum or stainless steel. Although not illustrated, a certification mark may be applied to one or both surfaces of Bond Jumper 100. Certification marks include UL, ETL, CSA, TUV, etc.

FIG. 2 illustrates a close-up isometric view of the Spring Grip 102. In this example embodiment, Bend 104 has a Relief Cut 201 that reduces the amount of material in the Bend 104. The Relief Cut 201 may be sized to achieve a desired force requirement to deflect the Upper Surface 106 away from the Lower Surface 105. The Relief Cut 201 size may also consider the type of material, and the thickness of material at the Bend 104. Upper Surface 106 may have one or more Upper Teeth 202 that protrude at an angle towards the Lower Surface 105. The Upper Teeth 202 may have one or more substantially sharp teeth or points meant to pierce the coating of a solar module frame. Upper Surface 106 may have an Upper Lip 204 that angles away from the Lower Surface 105 to help guide the Mouth 102 onto the solar module frame. Lower Surface 105 may have one or more Lower Teeth 203 that protrude at an angle up towards the Upper Surface 106. Lower Teeth 203 may have one or more substantially sharp teeth or points meant to pierce the coating of a solar module frame. Lower Surface 105 may have Lower Lip 205 that angles away from the Upper Surface 106 to help guide the Mouth 102 onto the solar module frame.

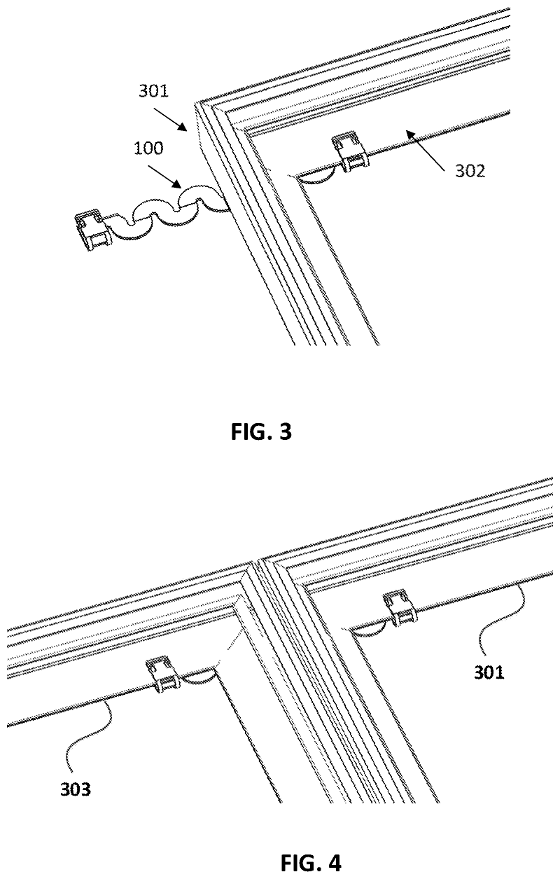

FIG. 3 illustrates the Bond Jumper 100 installed on a First Solar Module 301. A First Spring Grip is installed on the First Frame Flange 302 of a First Solar Module 301.

FIG. 4 illustrates a Second Solar Module 303 adjacent to a First Solar Module 301. A second Spring Grip is installed on the Second Frame Flange 303. The mid-section of the Bond Jumper is flat, allowing it to traverse under the two module frames.

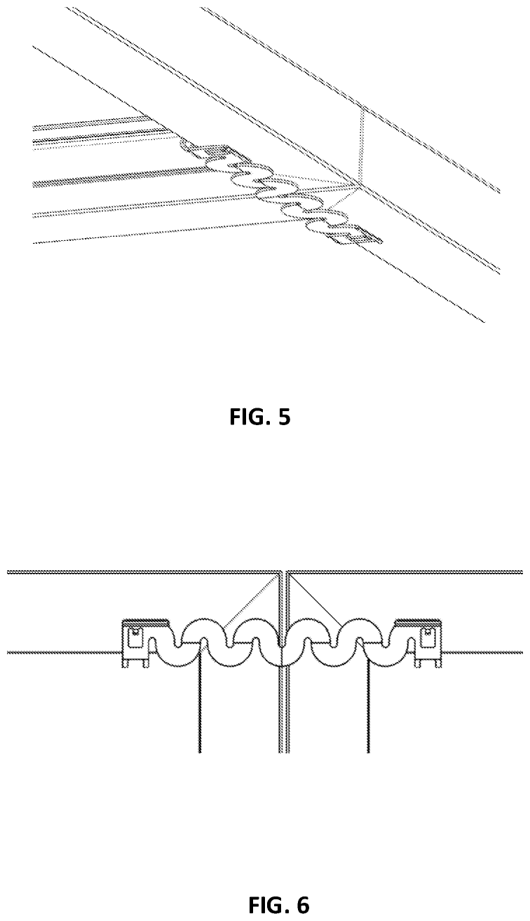

FIG. 5 illustrates an underside angle view of the two solar modules with a Bond Jumper 100 installed.

FIG. 6 illustrates an underside view of the two solar modules with a Bond Jumper 100 installed.

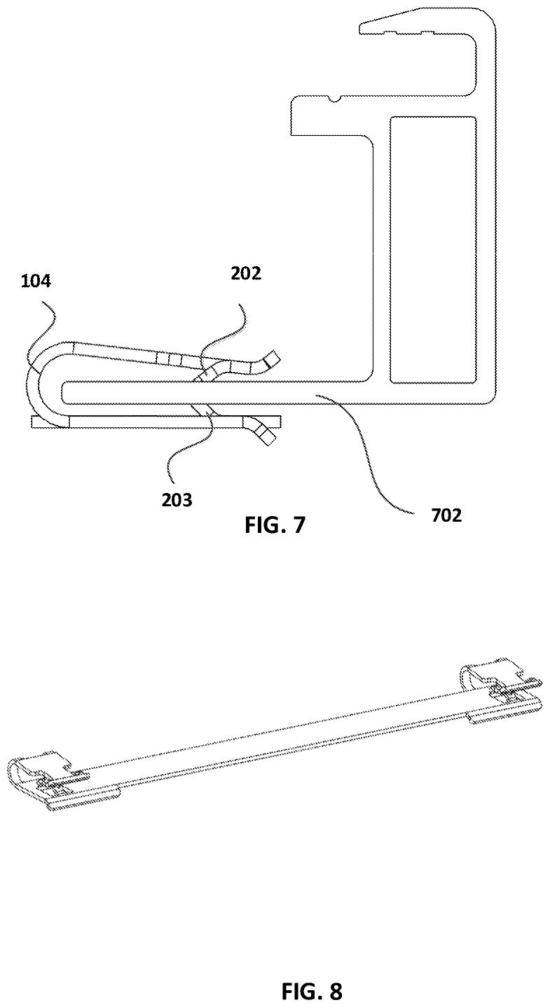

FIG. 7 illustrates a cut-away side view of a Bond Jumper 100 installed on a First Solar Module 301. In the installed configuration, Upper Teeth 202 are on one side of solar module flange 702. Lower Teeth 203 are on the opposite side of solar module flange 702. Bend 104 applies pressure on both sides of solar module flange 702 through Upper Teeth 202 and Lower Teeth 203. The pressure applied to each side of solar module flange 702 by Upper Teeth 202 and Lower Teeth 203 is sufficient to pierce typical coatings on the surface of solar module flange 702. The coatings might be paint, anodize, power coating, or any similar coating that provides corrosion resistance. By piercing the surface coating, an electrical bond is created providing a ground path between the solar module flange 702 and Bond Jumper 100. Also as illustrated in FIG. 7, the un-installed distance between Upper Teeth 202 and Lower Teeth 203 is less than the typical thickness of solar module flange 702.

FIG. 8 illustrates an alternative example of the present invention wherein the Body 101 is straight.

Installation of Bond Jumper 100 on a solar module can be done with both Spring Grips being aligned and then pushed onto the flanges at the same time. Or, one Spring Grip can be aligned and pushed onto one flange, then the other Spring Grip can be aligned and pushed onto the second flange.

Although illustrative embodiments have been described herein in detail, it should be noted and will be appreciated by those skilled in the art that numerous variations may be made within the scope of this invention without departing from the principle of this invention and without sacrificing its chief advantages. For example features that appear in one embodiment of a particular figure are also applicable to embodiments that are illustrated in other figures.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

What is claimed is:

1. A bond jumper, for providing an electrical bond path between two solar modules, the bond jumper comprising:
a first u-shaped spring grip comprising at least:
a first planar member comprising at least:
a first sharp tooth; and
a first lip;
a second planar member;
a first curved member connecting the first planar member and the second planar member;
a second u-shaped spring grip; and
a body connecting the first u-shaped spring grip and the second u-shaped spring grip.

2. The bond jumper of claim 1, wherein the second planar member further comprises at least:
a second sharp tooth;
a third sharp tooth; and
a second lip.

3. The bond jumper of claim 1, wherein the first curved member further comprises at least a relief cut between the first planar member and the second planar member.

4. The bond jumper of claim 1, wherein the second u-shaped spring grip further comprises at least a third planar member, a fourth planar member, and a second curved member connecting the third planar member and the fourth planar member.

5. The bond jumper of claim 1, wherein the first sharp tooth is configured to pierce a coating on one of the two solar modules when the bond jumper is attached to one of the two solar modules.

6. The bond jumper of claim 1, wherein the first sharp tooth protrudes from a central region of the first planar member.

7. The bond jumper of claim 1, wherein the first lip guides the first u-shaped spring grip onto one of the two solar modules.

8. The bond jumper of claim 1, wherein the body is s-shaped.

9. The bond jumper of claim 1, wherein the body is straight.

10. The bond jumper of claim 1, wherein the bond jumper is a substantially uniform thickness conductive material.

11. The bond jumper of claim 1, wherein the bond jumper is a made of aluminum or stainless steel.

12. The bond jumper of claim 1, wherein the bond jumper is formed using a progressive die.

13. The bond jumper of claim 1, further comprising a certification mark on at least one side of the body.

14. The bond jumper of claim 1, wherein the first u-shaped spring grip and the second u-shaped spring grip are on a same side of the body.

15. The bond jumper of claim 1, wherein a distance between the first sharp tooth and a second sharp tooth on the first planar member is less than a thickness of a solar module frame flange.

16. The bond jumper of claim 1, wherein a clamping force between the first sharp tooth and a second sharp tooth on the first planar member is sufficient to pierce a coating on a solar module frame flange.

17. A method for installing a bond jumper, comprising:
aligning a first u-shaped spring grip of the bond jumper on a first solar module frame flange;
aligning a second u-shaped spring grip of the bond jumper on a second solar module frame flange; and
simultaneously pressing the first u-shaped spring grip and the second u-shaped spring grip onto the first and second solar module frame flanges.

18. A method for installing a bond jumper, comprising:
aligning a first u-shaped spring grip of the bond jumper on a first solar module frame flange;
pressing the first u-shaped spring grip onto the first solar module frame flange;
aligning a second u-shaped spring grip of the bond jumper on a second solar module frame flange; and
pressing the second u-shaped spring grip onto the second solar module frame flange.
